(19) United States
(12) Patent Application Publication
(10) Pub. No.: US 2016/0221156 A1
(43) Pub. Date: Aug. 4, 2016

(54) HIGH TEMPERATURE OXIDATION RESISTANT BORON CARBIDE THIN FILM, CUTTING TOOLS USING THE THIN FILM AND METHOD OF MANUFACTURING THE SAME

(71) Applicant: Korea Institute of Science and Technology, Seoul (KR)

(72) Inventors: Young Joon BAIK, Seoul (KR); Jong-Keuk PARK, Seoul (KR); Wook Seong LEE, Seoul (KR)

(73) Assignee: Korea Institute of Science and Technology, Seoul (KR)

(21) Appl. No.: 14/970,923

(22) Filed: Dec. 16, 2015

(30) Foreign Application Priority Data
Jan. 30, 2015 (KR) 10-2015-0015353

(51) Int. Cl. B24D 18/00; C01B 31/36

(52) U.S. Cl. CPC B24D 18/00; C01B 31/36

(57) ABSTRACT

A superhard boron carbide thin film with superior high temperature oxidation resistance has a structure in which a boron carbide layer and a silicon carbide layer are repeatedly stacked in an alternating manner. Accordingly, the high temperature oxidation resistance of the boron carbide thin film is enhanced, allowing the application as coating materials for wear resistant tools such as cutting tools.

### CROSS-REFERENCE TO RELATED APPLICATION

This application claims priority to Korean Patent Application No. 10-2015-0015353, filed on Jan. 30, 2015, and all the benefits accruing therefrom under 35 U.S.C. §119, the contents of which in its entirety are herein incorporated by reference.

### BACKGROUND

1. Field

The present disclosure relates to a superhard boron carbide thin film with superior high temperature oxidation resistance, cutting tools using the thin film, and a method of manufacturing the thin film, and more particularly, a microstructure design for improving high temperature oxidation resistance of a boron carbide thin film.

2. Description of the Related Art

With the movement toward higher hardness of materials for use in the field of industry, performance improvement of cutting tools used in machining the materials is becoming a significant technical issue. Currently, cutting tools are being used in which a thin film coating having good mechanical properties such as hardness is formed on an ultralight or high speed steel material, and at present, the most common thin film material is a TiAlN-based material.

As the TiAlN-based material has a hardness corresponding to about 30 GPa and good oxidation resistance, the TiAlN-based material has a wide range of applications. However, because this hardness value is insufficient to meet the industrial demand, there is actually a need for development of materials having a higher hardness value.

Boron carbide is one of the hardest known materials behind diamond and cubic boron nitride, and as a reduction in hardness with the increasing temperature is small, boron carbide is a material that rather shows the highest hardness at high temperature of 1100° C. or above. Thus, due to its good mechanical properties, boron carbide has a range of applications including cutting tools, hard disk protective films, and bullet-proof materials, as well as beta-voltaic cells, thermoelectric elements, and neutron detectors using semiconductor properties.

On the other hand, to use for a diverse range of applications, fabrication of boron carbide in thin film form is needed. Recently, many studies have been made on deposition of a boron carbide film, and in the case of thin films, it is known that most of them has an amorphous crystal structure. However, it is reported that the hardness of these thin films has a super high hardness value of 40 GPa, showing possible uses as wear resistant thin films, for example, for cutting tools. Also, as previously described, because boron carbide is one of the hardest known materials to date, it is expected that it will be very effective in the application at cut or wear parts where contact temperature is high.

However, it is known that boron carbide is rapidly oxidized at 600° C. or above, and because boron oxide exists in liquid state at such temperature and has a tendency to evaporate easily, a crucial problem is that it is impossible to use it in high temperature atmosphere containing oxygen.

### SUMMARY

In this context, the present disclosure is directed to providing a superhard boron carbide thin film with superior high temperature oxidation resistance that enhances susceptibility to oxidation and maintains superior hardness.

The present disclosure is further directed to providing cutting tools using the superhard boron carbide thin film with superior high temperature oxidation resistance.

The present disclosure is further directed to providing a method of manufacturing the superhard boron carbide thin film with superior high temperature oxidation resistance.

To achieve the above object of the present disclosure, a superhard boron carbide thin film according to an embodiment of the present disclosure has a structure in which a boron carbide (BC) layer and a silicon carbide (SiC) layer are repeatedly stacked in an alternating manner.

In an embodiment of the present disclosure, each of the boron carbide layer and the silicon carbide layer may have a nanometer (nm) thickness.

In an embodiment of the present disclosure, the silicon carbide layer may serve as an oxidation preventive layer of the boron carbide layer.

In an embodiment of the present disclosure, the superhard boron carbide thin film may have a super high hardness value of at least 40 GPa.

In an embodiment of the present disclosure, the boron carbide layer may have an amorphous crystal structure.

In an embodiment of the present disclosure, the superhard boron carbide thin film may be used as coating materials for cutting tools or wear resistant tools.

To achieve another object of the present disclosure, there are provided cutting tools according to an embodiment for which the superhard boron carbide thin film having the above features is used as a coating layer.

To achieve still another object of the present disclosure, a method of manufacturing a superhard boron carbide thin film according to an embodiment includes depositing a boron carbide (BC) layer on a substrate, depositing a silicon carbide (SiC) layer on the boron carbide layer, and iteratively performing the deposition of the boron carbide layer and the deposition of the silicon carbide layer.

In an embodiment of the present disclosure, the depositing of the boron carbide layer and the depositing of the silicon carbide layer may include depositing each of the boron carbide layer and the silicon carbide layer to a nanometer (nm) thickness.

In an embodiment of the present disclosure, the depositing of the boron carbide layer and the depositing of the silicon carbide layer may use an asymmetric magnetron sputtering method.

In an embodiment of the present disclosure, the depositing of the boron carbide layer and the depositing of the silicon carbide layer may include adjusting the thickness of the boron carbide layer and the silicon carbide layer by adjusting a rotation rate of the substrate.

In an embodiment of the present disclosure, the depositing of the boron carbide layer and the depositing of the silicon carbide layer may have deposition conditions including a deposition pressure of 3 mtorr, a target output direct current electric power of 200 W, a substrate bias voltage of −100 V, and a deposition temperature in a range of 250° C. and 450° C.

Based on a microstructure design for improving functions of a boron carbide thin film, the superhard boron carbide thin film with superior high temperature oxidation resistance may inhibit the oxidation and maintain the hardness inherent to boron carbide through repeated stacking of a silicon carbide thin film having superior oxidation resistance and a boron carbide thin film to a few nanometer (nm) thickness. Accordingly, the boron carbide thin film with enhanced oxidation resistance has applications as a wear resistant thin film, for example, for cutting tools. Also, in the case of cutting tools, it is possible to continuously prevent the oxidation caused by the exposure to air of a new surface of the thin film exposed by the wear of the thin film during cutting.

### BRIEF DESCRIPTION OF THE DRAWINGS

FIG. 1 is a cross-sectional view of a boron carbide thin film according to an embodiment of the present disclosure.

FIG. 2 is a graph showing hardness changes at varying deposition temperature of a boron carbide thin film according to the present disclosure.

FIG. 3 is a cross-sectional transmission electron microscopic image of a thin film in composite form produced by stacking a boron carbide layer and a silicon carbide layer.

FIG. 4 is a curve showing weight changes of a thin film with the increasing temperature in air.

FIG. 5 is a graph showing hardness changes of a thin film with varying thicknesses of a single layer.

### DETAILED DESCRIPTION

The following detailed description of the present disclosure is provided with reference to the accompanying drawings, in which particular embodiments practicable by the present disclosure are shown by way of illustration. These embodiments are described in sufficient detail for those skilled in the art to practice the disclosure. It should be noted that various embodiments of the present disclosure are different but is not necessarily mutually exclusive. For example, without departing from the spirit and scope of the present disclosure in relation to one embodiment, particular shapes, structures and features stated herein may be implemented in another embodiment. It should be understood that changes and modifications may be made to locations or arrangements of individual components in each disclosed embodiments without departing from the spirit and scope of the present disclosure. Therefore, the following detailed description is not taken in a limited sense, and if appropriately described, the scope of the present disclosure is to be limited only by the appended claims along with the full scope of equivalents to which the claims are entitled. In the drawings, similar reference numerals denote same or similar functions throughout many aspects.

Hereinafter, preferred embodiments of the present disclosure will be described in more detail with reference to the drawings.

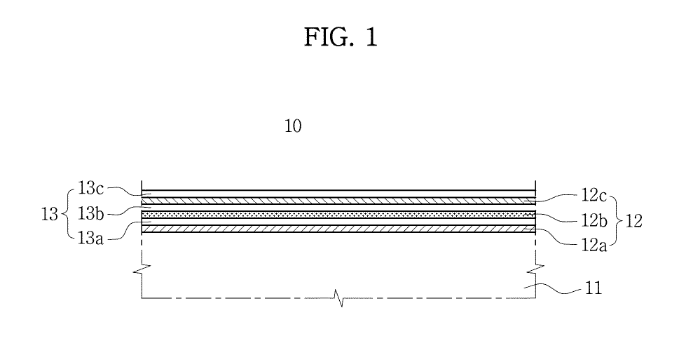

FIG. 1 is a cross-sectional view of a boron carbide thin film according to an embodiment of the present disclosure.

The boron carbide (BC) thin film according to the present disclosure is designed to solve the problem with susceptibility to oxidation in applications as a wear resistant thin film, and is directed to providing a boron carbide-based thin film with superior oxidation resistance that can enhance susceptibility to oxidation and maintain superior hardness of boron carbide through a composite structure with a silicon carbide (SiC) thin film having superior oxidation resistance.

Referring to FIG. 1, the boron carbide thin film 10 according to the present disclosure is formed by repeatedly stacking a boron carbide layer 12 having superior hardness and a silicon carbide layer 13 having superior oxidation resistance on a substrate 11.

That is, silicon carbide layers 13a, 13b, and 13c are respectively formed between a plurality of boron carbide layers 12a, 12b, 12c, to form a multilayer composite film having the boron carbide layers 12a, 12b, and 12c and the silicon carbide layers 13a, 13b, and 13c in an alternating arrangement.

The thickness of each layer of the boron carbide layers 12a, 12b, and 12c and the silicon carbide layers 13a, 13b, and 13c may have a nanometer (nm) level range. However, each layer does not necessarily have the same thickness, and the boron carbide layer and the silicon carbide layer do not necessarily have the same thickness. Each layer of the boron carbide layer and the silicon carbide layer may be adjusted according to the need.

The boron carbide thin film has superior hardness while it is rapidly oxidized at high temperature of 600° C. or above, and boron oxide exists in liquid state at such temperature and tends to evaporate easily, making it impossible to use in high temperature atmosphere containing oxygen.

Accordingly, as the silicon carbide layer 13 coats the boron carbide layer 12, the silicon carbide layer 13 serves as an oxidation preventive layer to prevent the oxidation of the boron carbide layer 12. If each of the silicon carbide layer and the boron carbide layer is just formed as a single layer, a wear resistant thin film is continuously removed in an environment in which wear progresses, for example, cutting, and as a result, the silicon carbide layer acting as an oxidation preventive layer is also removed, failing to prevent the oxidation.

To solve this problem, the present disclosure repeatedly stacks the nanometer (nm) thick boron carbide layer 12 and the nanometer (nm) thick silicon carbide layer 13 to allow the boron carbide layer 12 to continuously act as an oxidation preventive layer by continuously exposing the silicon carbide layer 13 during wear.

For example, in a cutting tool having the boron carbide thin film 10 of FIG. 1 as a coating layer, the uppermost silicon carbide layer 13c prevents the oxidization of the boron carbide layer 12c, and when the silicon carbide layer 13c and the boron carbide layer 12c are worn out, the underlying silicon carbide layer 13b prevents the oxidation of the boron carbide layer 12b. Similarly, when the silicon carbide layer 13b and the boron carbide layer 12b are worn out, the underlying silicon carbide layer 13a prevents the oxidation of the boron carbide layer 12a.

Although FIG. 1 shows the boron carbide layer 12a, the silicon carbide layer 13a, the boron carbide layer 12b, the silicon carbide layer 13b, the boron carbide layer 12c, and the silicon carbide layer 13c in a sequential order, the silicon carbide layer, the boron carbide layer, the silicon carbide layer, and the boron carbide layer may be deposited in a sequential order, and so long as two layers are repeatedly deposited, their order and the number of repetitions may be adjusted according to the need. However, when considering that the boron carbide thin film 10 is used as a coating layer for a cutting tool or a wear resistant tool, it will be desirable to form the silicon carbide layer as the uppermost layer.

The present disclosure attempted to form a composite structure through repeated deposition of boron carbide (BC) having superior mechanical properties and silicon carbide (SiC) having superior oxidation resistance to combine the properties of the two materials while maintaining superior mechanical properties of boron carbide (BC). In the case of cutting tools, this method has an advantage of continuously preventing the oxidation caused by the exposure to air of a new surface of the thin film exposed by the wear of the thin film during cutting.

Next, a detailed description of the present disclosure of oxidation prevention of the boron carbide thin film 10 according to an embodiment of the present disclosure will be provided.

Describing an embodiment for producing the superhard boron carbide thin film according to the present disclosure, the boron carbide thin film may be deposited using an asymmetric magnetron sputtering method. For example, a sintered boron carbide target with about 5 cm diameter may be used, and the deposition conditions are as follows: deposition pressure of about 3 mtorr, target output direct current electric power of about 200 W, substrate bias voltage of about −100 V, and deposition temperature of about 450° C. at room temperature.

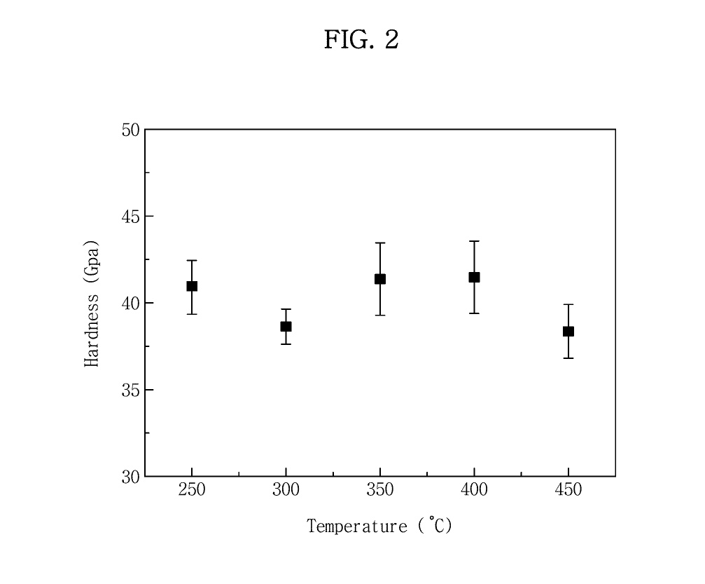

FIG. 2 shows the hardness of the boron carbide thin film deposited under the above conditions, as measured at varying deposition temperatures. The deposition temperature was respectively set to 250° C., 300° C., 350° C., 400° C., and 450° C. Referring to FIG. 2, it can be seen that a tendency to change as a function of deposition temperature was not observed, and hardness has a high value of about 40 GPa irrespective of deposition temperature. As a result of conducting an electron diffraction analysis using X-ray diffraction and transmission electron microscopes, the deposited thin film showed an amorphous structure. Thus, it was found that a film having a hardness value useful for cutting tools can be deposited even at comparatively low deposition temperatures.

Further, to test the effect of the superhard boron carbide thin film with superior high temperature oxidation resistance according to the present disclosure, a sintered silicon carbide target was placed parallel to a boron carbide target, and two layers were repeatedly deposited by rotating a substrate. The substrate may be a silicon substrate. Also, the thickness of each layer being deposited may be adjusted by adjusting the rotation rate of the substrate.

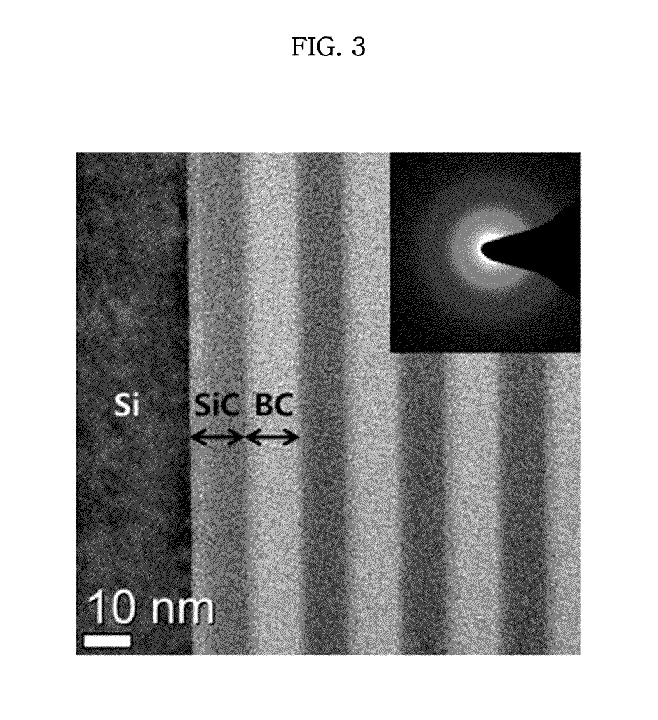

FIG. 3 is a cross-sectional transmission electron microscopic (TEM) image of a composite multilayer film deposited with a 10 nm thick single layer. Referring to FIG. 3, it can be seen that two layers are deposited in a repeated manner, and as can be seen from the diffraction result, a produced thin film has an amorphous structure.

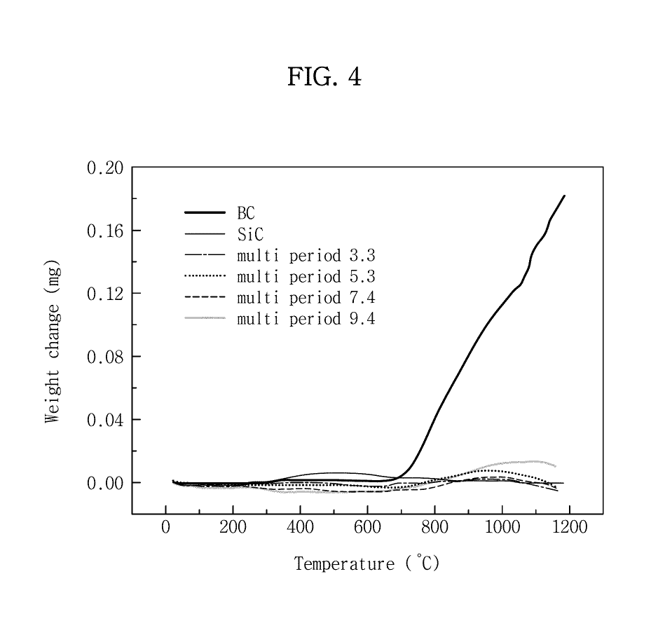

FIG. 4 shows measurements of weight changes of the thin film with the increasing temperature in dry air using thermal gravity analysis. As the weight increases as oxidation progresses, it is possible to measure the degree of oxidation in proportion to an increase in weight of the thin film.

Referring to FIG. 4, boron carbide (BC) increases in weight sharply at about 600° C. or above, while in the case of a composite film, an increase in weight is hardly observed up to 1200° C. Thus, it can be seen that oxidation reduces rapidly at high temperature by the silicon carbide (SiC) multilayer composite structure, and this oxidation preventive effect is irrelevant to an experimental range of thickness changes of a single film.

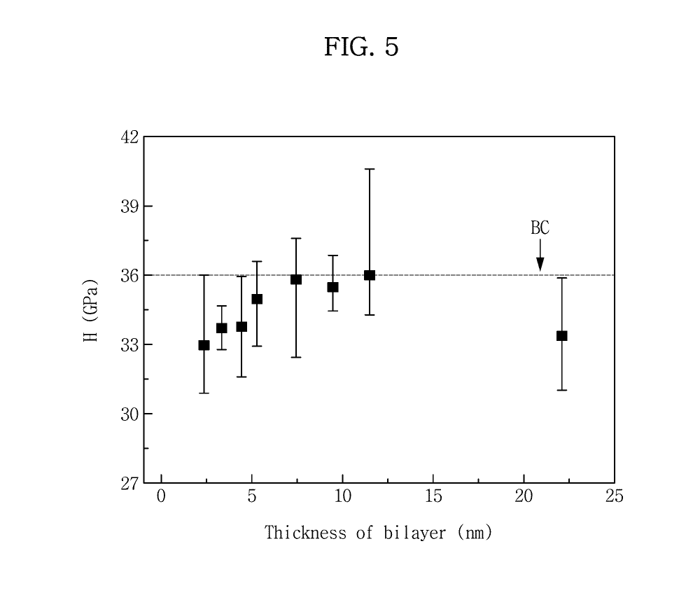

The hardness changes as a function of thickness of a single layer in the deposited composite multilayer film (an x axis thickness in FIG. 5 corresponds to a thickness of a single layer) are shown in FIG. 5.

Referring to FIG. 5, the measured hardness of boron carbide deposited under the same condition was about 36 GPa. It seems that the hardness increases a bit with the increasing layer thickness and then reduces, but taking an allowance into account, it may be determined that there is little change in hardness. Also, it shows a similar value to a hardness value (about 40 GPa) of boron carbide. Thus, the analysis reveals that a hardness reduction attributed to the multilayer structure is negligible.

In the case of this composite film, it is expected that the performance will be continuously maintained in an environment in which a new surface of the coating film is continuously exposed as the wear progresses during use. When the boron carbide layer is worn out, the underlying silicon carbide layer is exposed and serves as an oxidation preventive film in a continuous manner, allowing continuous oxidation prevention while maintaining the hardness during wear.

Further, because a wear rate varies depending on the cutting conditions or wear conditions, in keeping up with this, optimum wear resistance can be achieved by adjusting the thickness of the constituent layer. Thus, it is possible to embody a coating layer exhibiting optimum wear resistance through suitable design for a nano-scale thickness layer.

The present disclosure enhances the oxidation resistance of the boron carbide thin film having a super high hardness value, thereby allowing the application as wear resistant coatings, for example, cutting tool coatings, that can be used at high temperature. Also, a low coefficient of friction of an ultra-thin boron film resulting from a reaction with moisture in air on a surface of the boron carbide thin film predicted to oxidize during cutting produces an effect of applicability as a wear resistant lubricant coating.

While the present disclosure has been hereinabove described with reference to the embodiments, it will be understood by those skilled in the art that various changes in form and details may be made thereto without departing from the spirit and scope of the present disclosure as defined by the appended claims.

The superhard boron carbide thin film structure provided by the present disclosure can be applied to coating materials of cutting tools and wear resistant tools. Coated cutting tools can be variously used in machining materials and components of automobiles, aircrafts, and semiconductors. The cutting tools market shows a growth rate of 10% per year, and domestic production of superhard and high speed steel cutting tools amounts to 2,400 billion (export: 1,600 billion) (see Korea Machine Tool Manufacturer's Association as of 2012). 70% of them correspond to coating tools, and considering that most of coating materials applied to products are currently TiAlN-based materials whether national or international, it is expected that 50% or more of coating tools can be replaced according to the characteristics of the coating tools if suitability for practical applications is verified.

What is claimed is:

1. A superhard boron carbide thin film having a structure in which a boron carbide (BC) layer and a silicon carbide (SiC) layer are repeatedly stacked in an alternating manner.

2. The superhard boron carbide thin film according to claim 1, wherein each of the boron carbide layer and the silicon carbide layer has a nanometer (nm) thickness.

3. The superhard boron carbide thin film according to claim 1, wherein the silicon carbide layer serves as an oxidation preventive layer of the boron carbide layer.

4. The superhard boron carbide thin film according to claim 1, wherein the superhard boron carbide thin film has a super high hardness value of at least 40 GPa.

5. The superhard boron carbide thin film according to claim 1, wherein the boron carbide layer has an amorphous crystal structure.

6. The superhard boron carbide thin film according to claim 1, wherein the superhard boron carbide thin film is used as coating materials for cutting tools or wear resistant tools.

7. Cutting tools for which the superhard boron carbide thin film according to claim 1 is used as a coating layer.

8. A method of manufacturing a superhard boron carbide thin film, comprising:
depositing a boron carbide (BC) layer on a substrate;
depositing a silicon carbide (SiC) layer on the boron carbide layer; and
iteratively performing the deposition of the boron carbide layer and the deposition of the silicon carbide layer.

9. The method of manufacturing a superhard boron carbide thin film according to claim 8, wherein the depositing of the boron carbide layer and the depositing of the silicon carbide layer comprises depositing each of the boron carbide layer and the silicon carbide layer to a nanometer (nm) thickness.

10. The method of manufacturing a superhard boron carbide thin film according to claim 8, wherein the depositing of the boron carbide layer and the depositing of the silicon carbide layer uses an asymmetric magnetron sputtering method.

11. The method of manufacturing a superhard boron carbide thin film according to claim 10, wherein the depositing of the boron carbide layer and the depositing of the silicon carbide layer comprises adjusting the thickness of the boron carbide layer and the silicon carbide layer by adjusting a rotation rate of the substrate.

12. The method of manufacturing a superhard boron carbide thin film according to claim 10, wherein the depositing of the boron carbide layer and the depositing of the silicon carbide layer has deposition conditions including a deposition pressure of 3 mtorr, a target output direct current electric power of 200 W, a substrate bias voltage of −100 V, and a deposition temperature in a range of 250° C. and 450° C.
